(19) United States
(12) Patent Application Publication
(10) Pub. No.: US 2013/0222597 A1
(43) Pub. Date: Aug. 29, 2013

(54) System and Method for Playing an Adjunct Game During a Live Sporting Event

(71) Applicants: Kyle Brink, New York, NY (US); Mike Sommers, Montebello, NY (US)

(72) Inventors: Kyle Brink, New York, NY (US); Mike Sommers, Montebello, NY (US)

(73) Assignee: SportsHero, Inc., New York, NY (US)

(21) Appl. No.: 13/405,851

(22) Filed: Feb. 27, 2012

(51) Int. Cl. H04N 7/18

(52) U.S. Cl. 348/157; 348/E07.085

(57) ABSTRACT

The present invention relates to systems and methods for encouraging one or more viewers to engage with a broadcast of a live sporting event, and more specifically to a system and method for rewarding people for watching and interacting with live broadcast sporting events to promote loyalty to or improve recognition of sporting events, while collecting useful data about sports consumption habits as well as the rewards consumption patterns associated with those consumers.

### BACKGROUND

1. Field of the Invention

The present invention relates to systems and methods for encouraging one or more viewers to engage with a live sporting event and more specifically to a system and method for rewarding people for interacting with live broadcast sporting events to promote loyalty to or improve recognition of sporting events, while providing an opportunity to collect data about the sports consumption habits and rewards consumption patterns associated with those consumers.

2. Description of the Related Art

Over the past two decades there has been huge growth in the number of in-home entertainment options. Much of this growth has been driven by cable and satellite television, which not only provides more broadcast channel options than traditional over-the-air broadcast television could provide, but also provides the ability to view programming on demand. This on demand programming includes some of the same content (e.g. movies, sporting events, news, talk shows, dramatic series, comedy series, documentaries, family programming, educational programming, and reality programming). Radio, gaming and the availability of entertainment via the Internet has also grown over the past decade. Over the past few years the addition of paid satellite radio programming, new technologies, such as HD radio, have expanded the offerings that can be made available well beyond the stations that could be provided on AM and FM radio. While some of this content is pay-per-view or subscription based, much of the content is still supported by the sale of commercial advertising interspersed during the content.

Now there are even specialized companies that stream sports statistics and analysis that enable a viewer to access real-time statistics for a wide variety of sports without even having to watch the broadcast on television, radio or in person. For example Stats, LLC, provides real-time sports data, player tracking, mobile data application, team solutions, connections between a televised broadcast and the internet, and other functions for football, basketball, hockey. The Sports Network provides similar information for a variety of real-time sports and player tracking.

As a result of this proliferation of entertainment choices, there is a desire in the sports media and entertainment industry to attract and retain viewers/listeners, which may also be referred to herein as media and entertainment consumers or just consumers, to consume (i.e. listen and/or watch) content and be exposed to commercials.

Notwithstanding the proliferation of media and entertainment choices there is still a limit to the amount of content and commercial advertising that can be provided. Consequently, content providers have been looking for additional outlets to connect to their viewers. Among other things, content providers have been trying various means to use the Internet and other social media, such as Facebook® and Twitter®. Most of these means have involved connecting the viewers with one another to discuss programming and other media-related interests via social networks and destination websites where the viewers may consume additional content and be exposed to additional advertising.

There has also been an increase in the number and type of fantasy sporting games in which sports fans may partake. Many of the sporting websites, including ESPN, CBS, Fox Sports, host a series of different fantasy games for college and professional sports including, but not limited to, football, baseball, basketball, hockey, and even golf, tennis, and automobile racing. Many of these games have leagues set up for consumers to join, some of which are pay-to-play, others of which are free. Often there are prizes and rewards for users that play especially well. However, these traditional media attempts at Internet and social media offerings have often required too much effort for viewers to access, and require a significant amount of time to play. Moreover, these attempts, while widespread, do not provide for real-time, interactive play, as athlete selections are locked as sporting events begin. Consequently, there is a need for a system and method that will engage viewers and encourage them to interact with additional outlets in association with their sporting event viewing interests.

Reward or loyalty programs are ubiquitous. Generally these programs seek to reward certain buying behaviors that benefit a company. One common example of a loyalty program is that of airline frequent flyer programs. These frequent flyer programs began by providing points for every mile flown on a particular airline with a predetermined number of points redeemable for free airline tickets (e.g. 50,000 points or miles) or for upgraded service (e.g. 10,000 points to upgrade from Economy to First Class). As these frequent flyer programs evolved point awards were enhanced by a variety of factors, including providing premium points based on premium ticket pricing and based on how many annual miles the flyer flies (e.g. two points for every mile flown if the flyer flew in excess of 50,000 miles in the previous year). There was also an evolution in the redemption opportunities to include the ability to exchange points for airport club memberships and even physical goods. Many credit card companies and hotel chains have established programs that are similar to the airline frequent flyer example.

Other common examples are retail loyalty programs. Many of these programs provide a discount based on the presentation at the point of sale of a loyalty card or the input of unique information associated with the user's account, such as the user's telephone number.

In all instances, loyalty program sponsors gather at least a minimal amount of data (e.g. telephone number and/or zip code) directly from the user and then collect other data regarding the user's purchasing/traveling patterns through their continued use of their loyalty account. For instance, a grocer may use information from the frequent purchase of flowers to provide coupon offers. An airline may provide an email to a particular frequent flyer regarding reduced fares to vacation destinations that the consumer has previously flown to. A credit card loyalty program may provide reduced rate concert or sporting event tickets for certain card users to reward their level of card usage.

Loyalty programs have not been successfully deployed in association with sports media and entertainment content. There is a need to integrate features of a variety of loyalty programs into a meaningful interaction with viewers, sports media and entertainment providers, and content owners. There is an associated need to develop new loyalty programs that are specific to the sports media opportunity.

Media and entertainment providers and their advertising customers have long had data that purports to provide demographic and quantitative information regarding the consumers of media and entertainment. For instance, advertisers may be interested in knowing which television shows attract 20-35 year female viewers or which radio programs attract the most teenage boys. Various companies have developed over the decades that provide this type of data based on their relationships with a “random sample” of the viewing public. There is a need to improve the collection, variety, and granularity of data available to media and entertainment providers, content providers and advertisers. There is also an associated desire to have greater sample sizes and variety.

Over the last few years, the adoption of smart phones has accelerated particularly within highly desirable demographics for media and entertainment providers, content providers, and advertisers. Smart phones provide cellular telephone audio, SMS messaging, MMS messaging, data services, and sufficient processor power to run computer applications. There are many smart phone manufacturers who design smart phones and other devices for use with a variety of complex operating systems including, but not limited to, Android, Blackberry OS, iOS, Windows Mobile 7, and WebOS. Because smart phones are used regularly in daily life they provide an opportunity for advertisers and marketers. This opportunity, however, has been under-utilized, particularly to harness viewers for media content providers.

### BRIEF SUMMARY OF THE INVENTION

The present disclosure teaches various inventions that address, in part (or in whole) these and other various desires in the art. Those of ordinary skill in the art to which the inventions pertain, having the present disclosure before them, will also come to realize that the inventions disclosed herein may address needs not explicitly identified in the present application. Those skilled in the art may also recognize that the principles disclosed may be applied to a wide variety of techniques involving communications, gaming, marketing, reward systems, and social networking.

The present invention provides a new and innovative system and associated methods for encouraging individual viewers of live sporting events in a manner that may promote loyalty to and/or improve recognition of these events, while providing information and marketing opportunities to the entire audience or at an individualized level for content providers and advertisers. The present invention also preferably includes a social component and game features that could be added for those users who might be interested in a richer experience.

At its most basic level, consumers, also described as players and/or viewers herein, download an application to their mobile phone, tablet, laptop, or other device, which allows the consumer to access a user interface listing a variety of upcoming live sporting events for selection and then one or more athletes participating in that upcoming live sporting event for selection as part of an adjunct game that awards points to the consumer in substantially real-time, for selected actions taken by that athlete in the sporting event (as reflected by real-time data about the sporting event). Limited and/or timed substitutions of players are allowed in the adjunct game at various intervals during the live sporting event, such that participation in the adjunct game may be expected to increase the level of real-time engagement by the players with the sporting event. At the end of the sporting event, in some embodiments, the award points may be converted to loyalty points, which in turn may be exchanged for real-world rewards. Alternatively, the reward of besting one's teammates and friends, may be sufficient. In some embodiments, bragging rights may be the reward for playing and winning the adjunct game.

The live sporting event may be selected from (but is not limited to) a baseball game, a basketball game, a college football game, a professional football game, a hockey game, a college soccer match, a professional soccer match, a horse race, a gymnastics meet, a tennis match, a golf match, a sailing race, a boxing match, a chess game, a poker game, a bridge game, and an automobile race. But, as would be understood by those of ordinary skill in the art having the present specification, drawings, and claims before them, these examples (and other similarly related examples) would apply similarly to non-sporting events, other live sporting entertainment, and on-demand or pay-per-view programming, among other potential forms of live and broadcast entertainment.

To encourage further use and deeper interactions with adjunct game opportunities to redeem rewards for participation in the adjunct game, the viewers may be provided incentives, such as gift cards and product offerings. To this end, loyalty points may be awarded to the viewer that accumulated the most award points in the adjunct game associated with each sporting event. The awarded points can be converted to loyalty points. For example, the loyalty points could be directly or proportionally equivalent to the points awarded in the adjunct game. At its most basic, the system may preferably provide recognition to even the most passive users by providing incentives (e.g., awarded or loyalty points) for even just checking into the system or watching a broadcast sporting event with the system activated. Among the incentives there may also be different tiers of user status (i.e., Fan to Super Fan). The loyalty points may be used to increase and maintain interactions between consumers and content/media providers, including, but not limited to engaging viewers with commercials during the broadcast, involving them in polling exercises, and exposing them to additional adjunct content. For instance, the viewer could be awarded additional adjunct game points in selected instances for playing different adjunct games. In this way, the system provides a tool for media and sports networks to attempt to effect viewing behavior changes through a system of tiered rewards of their choosing.

The additional user interaction may be context sensitive and preferably use analytics to automatically cluster users based on attributes (e.g. user demographics, behavior, and show, sports, and team preferences). The system may remind viewers of upcoming sporting events, provide trends in sports data, and provide information about friends' sporting event viewing habits and preferences. These features should allow the system to offer more relevant rewards to each user segment. It is also contemplated that the viewers would get additional loyalty points for referring additional users; reviewing a newsletter; providing additional user profile information (e.g. email address, Facebook® account, Twitter® account, mobile phone number, third party loyalty card numbers); opting-in for SMS text messaging; participating in a user survey; logging onto the system via Facebook® and/or Twitter®; and participating in social networking discussions about the content and/or the process. The application may also include a chat room associated with each live sporting event selected by the consumer. To facilitate this functionality, the system would preferably pull comments in from Facebook® and Twitter® and then allow the viewer to comment on the posts and tweets that have been pulled in. The consumers may additionally (or alternatively) engage with the system using their personal and/or tablet computer if they are interested in having more robust interactions with the system.

In one embodiment, the method further comprises facilitating the viewer's redemption of the loyalty points for rewards, where the reward is a real-world reward that is physically (or where possible electronically) sent to the viewer. The loyalty points should be easy to redeem across multiple digital platforms, including via mobile devices. Data regarding each user's point redemption activities may be utilized to capture user preferences, including but not limited to, brand preferences. For example, a user redeeming points for a team jersey (or other team-oriented products) may indicate a preference for that sporting team. Similarly, redemption for a 4-pack of razor blades may indicate a desire for a particular product as approved by others.

The system and associated methods will provide various revenue generation opportunities including, by way of example, media and sponsorship sales, charter marketing partnerships, direct marketing and promotional offers, aggregated sales data, point sales, affiliate revenues associated with reward redemption and strategic partner revenues. In particular, the system and associated methods provide the ability to conduct push marketing via the computer applications deployed on computers and smart phones as well as via email and SMS messaging. That push marketing may be narrowly tailored based on information collected by the system regarding the demographics and interests of each viewer.

Raw data analytics may also provide an additional potential revenue source. In combination with secure, private collection of data from the viewers, a nearly endless variety of analytics may be conducted. For instance, the demographic, content viewing and reward selection data may combine to tell the owner of certain content that their 20-30 year old viewers are interested certain sports or an upcoming adjunct game between the adjunct game players favorite and non-favorite teams. In another example, the data could show a correlation between viewers who redeemed points for razor blades and viewership of hockey. As such, the obtained data may provide the ability to advertisers to target certain demographic groups. For example, a razor manufacturer could choose to send razor ads to the mobile phones of 18-22 year old males who recently watched a sporting event where their favorite athlete used their razor.

In one embodiment, the invention relates to a system for encouraging one or more viewers to engage with a live sporting event comprising means for receiving log-in information from one or more viewers operably connected with a database for storing viewer accounts; means for receiving a selection of a live sporting event from each of the one or more viewers operably connected to a database for storing information relating to live sporting events; means for receiving a selection of at least one athlete participating in the selected live sporting event from each of the one or more viewers operably connected to a database for storing team information; means for receiving data indicative of certain play-by-play action in the live sporting event in substantially real-time; means for comparing the data indicative of certain play-by-play action with each of the viewers' selected athletes; and means for awarding game points to each of the viewers if the selected athlete performs a pre-designated act. In another embodiment, the system may further comprise means for rewarding the viewers based upon their awarded game points operably connected to a database for storing reward information.

In another embodiment, the awarded game points are equivalent to loyalty points, which can be redeemed for rewards. Alternatively, the awarded game points may be proportionally converted to loyalty points. The system may include a reward fulfillment engine that facilitates a viewer's redemption of points for rewards and distributes these rewards. The reward fulfillment engine may provide a catalog containing a plurality of rewards that can be selected by the viewer by redemption of a predetermined number of loyalty points.

In another embodiment, the invention relates to a method for encouraging one or more viewers to engage with a live sporting event comprising receiving on a central computer log-in information from the one or more viewers; receiving on a central computer a live sporting event selection from each of the viewers; receiving on a central computer a selection of at least one athlete participating in the selected live sporting event; receiving on a central computer data indicative of certain play-by-play action in the selected live sporting event in substantially real-time; comparing the received data indicative of certain play-by-play action with each of the viewers' selected athletes; and awarding game points to the viewers if the selected at least one athlete performs a pre-designated action.

In still another embodiment, the method further comprises allowing the viewer to substitute at least one athlete for the at least one selected athlete; and awarding points to the viewer if the substituted at least one athlete performs a pre-designated act.

In another embodiment, the method may also include determining if the one or more viewers are watching or listening to a broadcast of the live sporting event. In this embodiment, game play may be limited to those consumers who are actually watching the underlying sports event. The method may also determine whether the consumer is present at the live sporting event.

These and other advantages and uses of the present system and associated methods will become clear to those of ordinary skill in the art after reviewing the present specification, drawings, and claims.

### BRIEF DESCRIPTION OF THE FIGURES

For a better understanding of the present disclosure, non-limiting and non-exhaustive embodiments are described in reference to the following drawings. In the drawings, like reference numerals refer to like parts through all the various figures unless otherwise specified.

FIG. 1 illustrates one embodiment of a system in accordance with one approach to the present invention.

FIG. 2 more specifically illustrates the centralized functions of the system of FIG. 1.

FIG. 3 is a flow diagram illustrating one embodiment of a method in accordance with one approach to the present invention.

FIG. 3A is a flow diagram illustrating additional potential aspects of the embodiment of FIG. 3 accordance with one approach to the present invention.

FIG. 3B is a flow diagram illustrating additional potential aspects of the embodiment of FIG. 3 accordance with one approach to the present invention.

FIG. 3C is a flow diagram illustrating additional potential aspects of the embodiment of FIG. 3 accordance with one approach to the present invention.

FIG. 4 illustrates some of the details associated with the viewer feedback engine of the system illustrated in FIG. 1.

FIG. 5 illustrates a flow diagram of the potential interactions a viewer may have in association with one embodiment of the system illustrated in FIG. 1.

FIG. 6 illustrates one potential user interface approach to an introduction screen that may be used in association with one example of an application that may be downloaded onto a smart phone (or other portable device) with the understanding that the smart phone and graphical user interface illustrated in the figures is merely intended to provide an example of one potential deployment of the application without limiting the invention to that particular type of smart phone, operating system, or graphical user interface.

FIG. 7 illustrates another user interface approach to signing into the application using a social media sign-in feature.

FIG. 8 illustrates another user interface approach to a “get started” screen in the installed application that would preferably be used in association with the computer application deployed on the exemplary smart phone of FIG. 6, requesting the user to choose a game function.

FIG. 9 illustrates one user interface approach in the installed application asking that the user select a function that would preferably be used in association with the computer application deployed on the exemplary smart phone of FIG. 6.

FIG. 10 illustrates an optional user interface in the installed application that may be used in association with the computer application deployed on the exemplary smart phone of FIG. 6 to confirm the user's game selection.

FIG. 11 illustrates one potential user interface approach to a “reminder” screen in the installed application that may be used in association with the exemplary smart phone of FIG. 6.

FIG. 12 illustrates one user interface approach to an “invitation to friends” screen in the application that would preferably be used in association with the computer application deployed on the exemplary smart phone of FIG. 6.

FIG. 13 illustrates one user interface approach to an initial “athlete select” screen in the installed application that may be used in association with the exemplary smart phone of FIG. 6.

FIG. 14 illustrates one user interface approach to user interface where a user may select one or more athletes in the from a selected sporting event broadcast that may be used in association with the exemplary smart phone of FIG. 6.

FIG. 15 illustrates one user interface approach to an “athlete selected” screen in the installed application that may be used in association with the exemplary smart phone of FIG. 6.

FIG. 15A illustrates another user interface approach to an “athlete selected” screen in the installed application that may be used in association with the exemplary smart phone of FIG. 6., where more than one athlete is selected

FIG. 16 illustrates one user interface approach to allow a user to post adjunct game information to a social media site.

FIG. 17 illustrates one user interface approach for a user to initiate a “smacktalk” function to interact with other viewers.

FIG. 18 illustrates one user interface approach for a “smacktalk” chat room for conversation between the users.

FIG. 19 illustrates one user interface approach to a listing of users' selection of particular athletes that may be used in the installed application on the exemplary smart phone of FIG. 6.

FIGS. 20A-20B illustrate one user interface approach to a menu function, that may be used in the installed application on the exemplary smart phone of FIG. 6, which also has a scroll function, so that all of the information can be viewed by scrolling.

FIG. 21 illustrates a ticker window that can be viewed on the exemplary smart phone of FIG. 6, and expanded using a vertical pull-up handle.

FIG. 22 illustrates one user interface approach showing an individual user's score for the adjunct game.

FIG. 23 illustrates one user interface approach for viewing a user's selected athlete, with additional adjunct game options.

FIG. 24 illustrates one user interface approach for completing an adjunct game, showing each user's relative points for that adjunct game.

FIG. 25 illustrates three user interface approaches to different occurrences in a sporting event.

FIG. 26 illustrates a user interface approach for viewing a user's playing history for the adjunct game.

FIG. 27 illustrates a user interface approach where a user can view an advertisement for a product or service.

FIG. 28 illustrates one user interface approach to rewards redemption that may be used in association with one example of the installed application as it may be deployed on the exemplary smart phone of FIG. 6, while illustrating the types of rewards that may be provided in association with one or more embodiments of the present invention.

FIG. 29 illustrates a flow diagram of a method of audio check-in verification that may be used in association with one embodiment of the system illustrated in FIG. 1.

### DETAILED DESCRIPTION OF THE INVENTION

The present invention provides a system and method that can be utilized with a variety of different client devices, including but not limited to desktop computers and mobile devices such as PDA's, smart phones, cellular phones, tablet computers, and laptops, to reward consumers of live sporting events (also interchangeably referred to herein as “viewers,” “players,” and/or “users”) in a manner that should promote loyalty to and/or improve recognition of the sporting event, while further providing information and marketing opportunities. While the specification speaks in terms of live sporting events and athletes, one of ordinary skill in the art would understand the application of the present invention to a variety of events outside the sport domain. For instance, the present invention in its various embodiments could be used in association with a beauty pageant, talent competition, reality television show, and/or game show that would be preferably broadcast live. Other applications of the invention will become more apparent after having read the present specification and claims. Thus, while the invention may be embodied in many different forms, the drawings and discussion are presented with the understanding that the present disclosure is an exemplification of the principles of the inventions disclosed herein and is not intended to limit any one of the disclosed inventions to the embodiments illustrated.

In one embodiment, the invention relates to a system for encouraging one or more viewers to engage with a live sporting event comprising means for receiving log-in information from one or more viewers operably connected with a database for storing viewer accounts; means for receiving a selection of a live sporting event from each of the one or more viewers operably connected to a database for storing information relating to live sporting events; means for receiving a selection from each of the one or more viewers of at least one athlete participating in the selected live sporting event operably connected to a database for storing team information; means for receiving data indicative of certain play-by-play action in substantially real-time for the selected live sporting event; means for comparing the data indicative of certain play-by-play action with each of the viewers' selected at least one athlete; and means for awarding points to each of the viewer's if the selected at least one athlete performs a pre-designated act.

The live sporting event may be selected from (but is not limited to) a baseball game, a basketball game, a college football game, a professional football game, a hockey game, a college soccer match, a professional soccer match, a horse race, a gymnastics meet, a tennis match, a golf match, a sailing race, a boxing match, a chess game, a poker game, a bridge game, and an automobile race. The live sporting event may also be a series of sporting events such as a World Cup or Olympics.

In some embodiments the system may further comprise means for rewarding the viewers based upon their awarded points, which may be operably connected to a database for storing reward information. In some embodiments, the award points may be equivalent to loyalty points, which loyalty points can be redeemed for rewards. Alternatively, the awarded points may be converted to loyalty points for each pre-determined number of awarded points. In another alternative, the winner of each adjunct game may receive a predetermined number of loyalty points, which predetermined number may be advertised to entice viewers to engage with a particular sporting event. In yet another alternative, the reward for playing and winning the adjunct game may be bragging rights over one's friends and other adjunct game players. For some, bragging rights is a sufficient reward for playing the adjunct game.

The system may also comprise a reward fulfillment engine that facilitates a viewer's redemption of loyalty points for rewards, and distributes the rewards. The reward fulfillment engine may provide a catalog containing a plurality of rewards that can be selected by the viewer by redemption of a predetermined number of loyalty points.

In another embodiment, the invention relates to a method for encouraging one or more viewers to engage with a broadcast of a live sporting event comprising receiving on a central computer log-in information from the one or more viewers; receiving on a central computer a live sporting event selection from each of the viewers; receiving on a central computer a selection of at least one athlete participating in the selected live sporting event; receiving on a central computer data indicative of certain play-by-play action in the selected live sporting event in substantially real-time; comparing the received data indicative of certain play-by-play action with each of the viewers' selected athletes; and awarding points to the viewers if the selected at least one athlete performs a pre-designated act.

In still another embodiment, the method further comprises allowing the viewer to substitute at least one athlete for the at least one selected athlete; and awarding points to the viewer if the substituted at least one athlete performs a pre-designated act. The awarded points can be equivalent to loyalty points or converted to loyalty points.

In one embodiment, the method further comprises facilitating the viewer's redemption of the loyalty points for rewards, where the reward is a real-world reward and is sent to the viewer.

In another embodiment, the method may also include determining if the one or more viewers are watching or listening to a broadcast of the live sporting event.

In today's world, statistics for just about anything are available in real-time, and in particular there is a great demand for real-time sporting news. There are companies that specialize in obtaining and providing virtually every statistic for every play in every professional game. Two exemplary companies that provide this content and information are Stats LLC (Northbrook, Ill.) and The Sports Network (Hatboro, Pa.). These companies offer a wide variety of sports data, and cover baseball, college and professional basketball, hockey, soccer, college and professional football, as well as individual sports including, but not limited to, automobile racing, tennis, golf and many more. Within each sport, statistics are available for any event, at any time, at any location. For example, statistics available for basketball can include, but are not limited to shot blocking, assists, 2-pt field goal, 3-pt field goal, free throw (i.e, both offensive and defensive points can be obtained). It would also be possible for someone to generate their own play-by-play data for a variety of events.

While the novel adjunct game disclosed in the present specification can be played for any sport, and in particular, any team sport, we exemplify the invention using basketball. One of ordinary skill in the art would understand that this came can be played for a wide variety of sports, or any sport where play-by-play actions can be determined and/or provided. For example, in football, points could be awarded for receptions, rushing yards gained (or lost), completed passes, field goals/extra points, tackles, safeties, and interceptions. A baseball game might have data regarding on base percentage, singles, doubles, triples, stolen bases, home runs, runs, strikeouts, flyouts, putouts etc. In hockey, a player might earn points for their athlete's goal or assist scoring, penalty minutes, shots on net, goalie saves, etc. In golf, points might be awarded for birdies and eagles, pars might count for zero points, and bogeys (or worse) might have negative point values assigned. Even racing sports can be played with the inventive game. For example, one can measure lap times, laps led, pit stop times, and so on. Table 1 below illustrates one potential scoring scheme, in particular for college basketball.

TABLE 1

| | | Field | 3-Pt. | | Free | | | | | |
|---|---|---|---|---|---|---|---|---|---|---|
| | Field | Goal | Field | Free | Throw | | | | | |
| Play | Goal | Miss | Goal | Throw | Miss | Rebound | Assist | Steal | Turnover | Block |
| Point | 2 | 0 | 3 | 1 | 0 | 2 | 1 | 2 | −2 | 5 |
| Value | | | | | | | | | | |

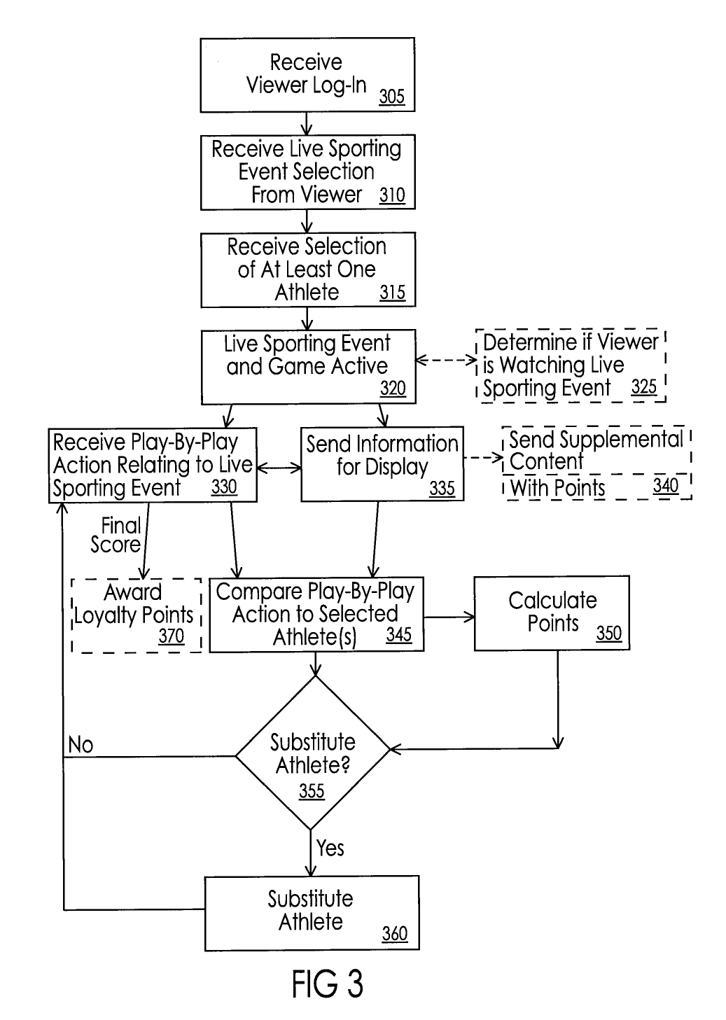

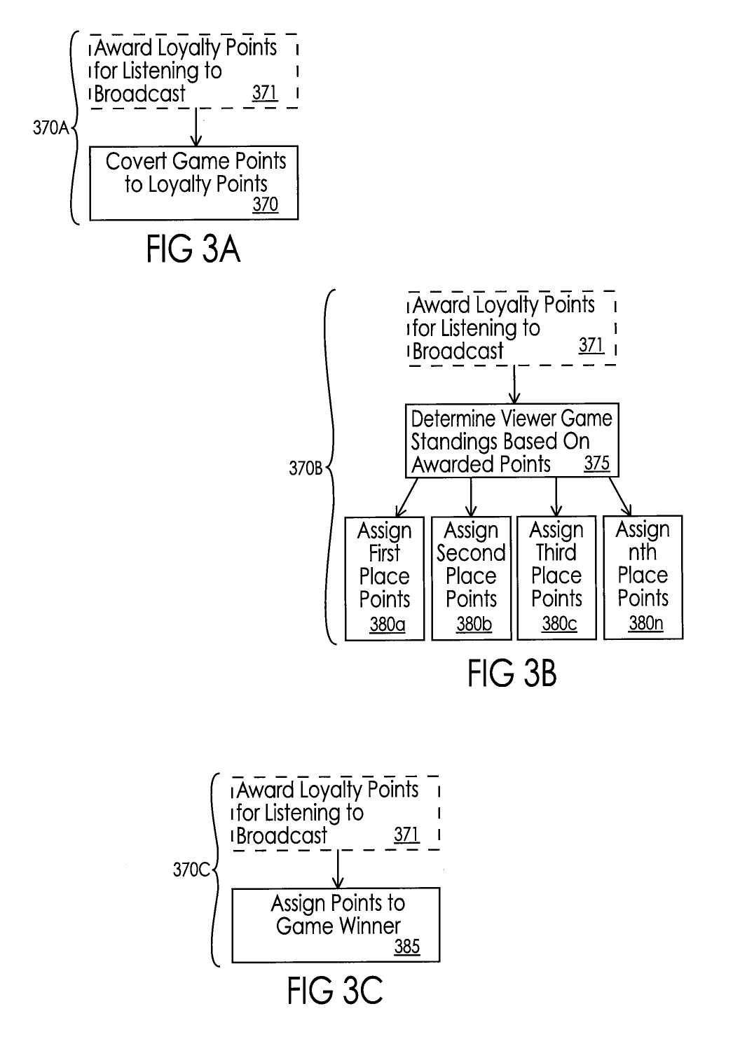

Turning to the adjunct game itself, and using basketball as the exemplary sport, a player watching a basketball game (in the arena, on television or via the radio) checks into the system, selects the sporting event, and picks, for example, one athlete expected to participate in the basketball game. FIGS. 3-3C illustrate the flow of the adjunct game. From this process flow it will be understood that the arrangement and type of the information displayed can vary throughout the adjunct game set-up and play.

As shown in FIG. 3, the system receives a log-in from one or more viewers 305. Once the viewers are logged into the adjunct game, they can make a selection of the live sporting event with which they wish to engage, the selection received by the system 310. Next, the system receives the viewers' selection of athlete participating in the live sporting event 315. Once the live sporting event begins 320, the system receives, in substantially real-time, a play-by-play feed of the certain actions occurring in the live sporting event 330. The actions are compared to the viewers' selections 345, and the viewers are awarded points based upon the athlete's performance 350. During the live sporting event, the viewers may make substitutions as allocated by the adjunct game 345, 355, 360. During the adjunct game, the system may also determine if the viewer is watching the live sporting event 325. In one embodiment, however, the viewers may not be required to watch or listen to the sporting event. A viewer can, for example, select athletes prior to the live sporting event and keep that selection for the entire adjunct game—and then simply not engage with the live sporting event. However, a viewer that is not viewing the selected live sporting event is far less likely to “win” the adjunct game than a viewer that is engaged in real time with the sporting event. Information is sent to the viewer's smart phone for display 335. This information can include athlete or team statistics, videos, photographs, scoring tickers, etc. In addition, supplemental content, such as advertisements, quizzes, etc. can be sent to the viewer's smart phone 340. After the live sporting event is concluded (i.e. “Final Results”), the adjunct game ends. In some embodiments, an adjunct game player may be present at the live sporting event. In this case, and in the case of a non-viewing adjunct game player, more than one game can be entered simultaneously.

In many embodiments, the end of the adjunct game will result in the awarding of points to one or more of the viewers who were involved in the adjunct game. For instance, FIG. 3A shows that each of the viewer's awarded points can be converted directly to loyalty points 370. In another example, FIG. 3B shows that the standings of each viewer within the adjunct game is determined based upon the awarded points 375 and then first, second, third and nth place loyalty points are assigned 380a, 380b, 380c, and 380n. As would be understood by those having the present specification, it is a matter of choice whether the system rewards points to a particular number of places. For instance, one system may reward points only to first, second, and third place viewers. In yet another example, FIG. 3C shows that loyalty points may be assigned only to the viewer that placed first in his/her group 385. In each example, it is shown that loyalty points may optionally be reward simply for participating in the adjunct game.

During the play of the adjunct game, for each positive play or action made by the selected athlete, the player's adjunct game score increases. In one embodiment, the point value can vary by what type of action the athlete performs (one representative example being illustrated in Table 1 above). In addition, if an athlete makes a poor play, commits an error, foul or mistake, the adjunct game player may receive negative points. The point values for each action in the tables (e.g., positive, neutral, or negative actions) can be predetermined by the context of the sport. Not all possible actions that may be documented by the providers of play-by-play data need to be reflected in the point tables. To the extent an action is not reflected in the points table, the occurrence of such event will result in no change to the point totals in the adjunct game even though the event may affect the outcome of the sporting event.

Over the course of a game, a player is allowed a specified number of athlete substitutions. The number of substitutions allowed may be predetermined to be any number and can vary by sport. The number of athlete substitutions can be governed by the type of sporting event. For instance, the number of periods or innings in a sporting event may impact the number of substitutions provided. For example, in basketball, a player may be able (but not required) to make up to five athlete substitutions per half In football, substitutions may be allowed with each change of possession. Athlete selection may also be based on whether a team is in an offensive or defensive posture. Thus, athlete substitutions may be made by an adjunct game player based upon how the player believes that the athlete will perform in any particular situation. In addition, for sporting events where there are larger number of players (e.g., football or hockey), the selection of more athletes may be allowed. In general, the more engaged a player of the adjunct game is with the live sporting event, the more likely that player is to amass awarded game points. In addition, the engaged player will be more aware of advertisements and other information emanating from the system.

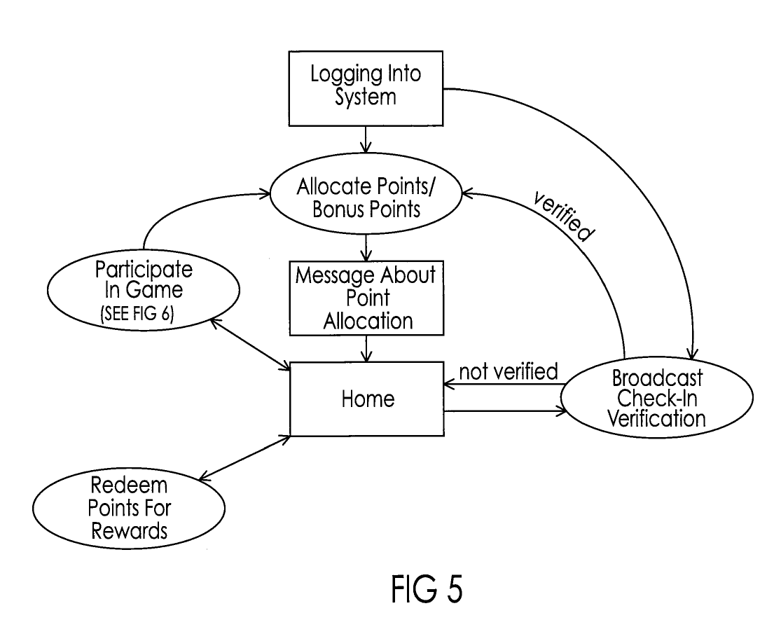

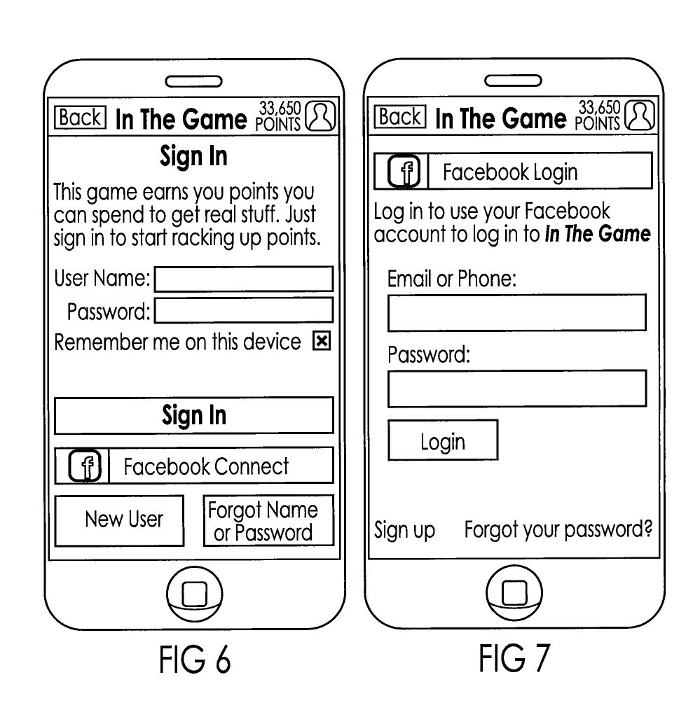

FIG. 5 illustrates one potential flow for interaction of viewer 40 with the system. As illustrated in FIG. 5, when a viewer logs into the system they may be immediately logged into the adjunct game. After a successful log in, they may access and play the adjunct game, and receive points based upon how their selected athlete performs in a selected live sporting event. FIG. 6 illustrates one potential embodiment of a sign-in screen. If a player does not yet have an account, he/she will select the “Create Account” option. To create an account a player enters an e-mail address to be associated with the account, and then enters a user name and password. FIG. 7 illustrates an alternative sign-in protocol, where a player can sign into the inventive game using a social media account, such as Facebook®. In that case, the system will attempt to create a player account using the player's Facebook® e-mail and user name. If a user name has been previously taken, the system will deliver an error message and prompt the player to enter another user name. All fields, however, still remain populated, so that information does not have to be entered more than once. If the entered e-mail exists in the system, but does not match the user name, the system will send another error message stating that the “e-mail address already has an account. Log in using your user name and password.” If the user name and e-mail do not exist in the system, the chosen user name will be created and the player signed in.

The player, having previously signed up, and generated a log-in name and password, can enter the program and begin winning points. By signing in, the player ensures that all points awarded during adjunct game play are accrued to the correct user account, and that all leaderboard information can be accurately listed. Signing in may be skipped if the player elects to have their device “remember” their information. In addition, should a player forget their user name and/or password, a button labeled “Forgot User Name or Password” can be included. Once accessed, the system will determine the identity of the player, and forward the sign-in information to the player. This information can be transmitted by a method including, but not limited to, e-mail, texting, and messages to a social networking sites, such as Facebook®.

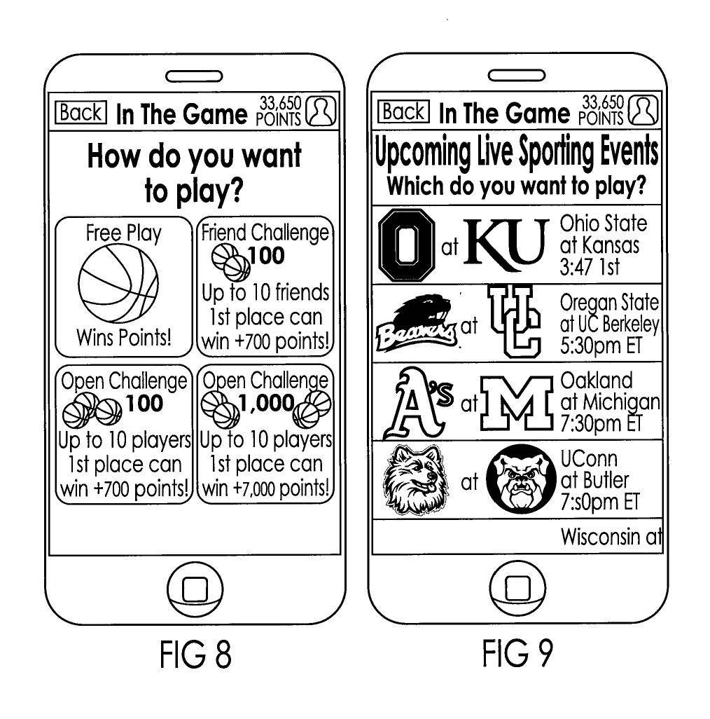

Several levels of the adjunct game are available for play, as shown in FIG. 8, which illustrates a screen shot where a player can choose what type of adjunct game to play. As illustrated here, a player can choose to play an open, or free, play and win points depending upon the performance of the chosen athlete(s).

For example, there are adjunct games that are free to join, and challenge adjunct games that a player must exchange a certain number of loyalty points to join. In either version of the adjunct game, a player can win award points to be exchanged for loyalty points and ultimately for rewards. Challenge adjunct games can be open challenges or challenges played among friends. A player may exchange a number of loyalty points to take part in the challenge adjunct games. In instances where the viewers exchange loyalty points to play the adjunct game, the higher the number loyalty points exchanged, the more points a player can win if they reach certain predetermined goals in the adjunct game. In each of these adjunct games, the players are awarded points on how their selected athlete(s) perform in the actual broadcast event.

During game setup, the player first chooses the game mode, selecting from open mode, or exchange modes, where the player must ante up a certain number of points. As depicted in FIG. 8, a player may choose to play a 100 loyalty point adjunct game or a 1,000 loyalty point adjunct game. The potential winnings are higher for the higher loyalty point adjunct games as well. Free play, which is the preferred approach, is available to all players on all available adjunct game versions.

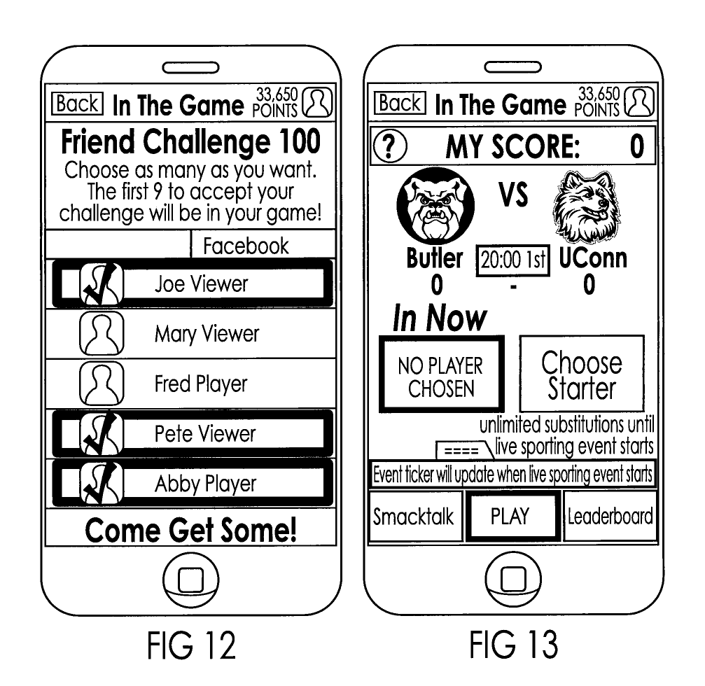

A friend challenge can have a loyalty point exchange requirement, typically of about 100 loyalty points, although that number may be selected at any level. This mode is available to signed-in players and allows a player to invite up to 10 friends to play an adjunct game. Of course, the number of invited friends can vary. In one embodiment, the winner of a friend challenge may receive a higher percentage of possible awarded points, which may be converted to loyalty points. These amounts, too, vary, and in a manner determined prior to play. Once the mode of play is selected, the player will then choose a sporting event. After the sporting event is chosen, an invitation screen can be accessed by the player, and the invitees entered. The invitation can be distributed via regular e-mail, or can be taken from the player's social media listings. For example, a player can use his Facebook® account or any other contact list that might be available electronically to obtain addresses for the invitations. In the friend challenge mode, the starting player can choose as many friends to invite as desired. However, as exemplified, only the first nine to accept the challenge will be able to participate in the adjunct game (see FIG. 12).

Other available challenge games include an open challenge with a requirement of about 100 loyalty points. As above, this number is not fixed, and can be set to any desired amount. The number of players can be limited to 10 per game, or the game could be played with either fewer or more players. Similar to the friend challenge above, the winner of an open challenge receives a greater number of awarded and/or loyalty points. The open challenge is a matchmade game. That is, the player is added to an existing adjunct game, or, if no existing adjunct game is available, the system will create a new game. If a player elects to play an open challenge, the player is taken to a “choose a sporting event” screen. Here the player selects the desired sporting event to play along with, and confirms the exchange of 100 loyalty points (or whatever the amount was preselected for that adjunct game). Using matchmaking logic, discussed below, the player is added to an available adjunct game. Other challenge adjunct games may have a requirement of about 1000 points, which would result in the amount of loyalty points available to win is correspondingly higher. In this manner, it should be understood that the exchange amounts and the ultimate winning points can be varied

Matchmaking for the open challenges starts when a player selects an open challenge game. When that players selects a sporting event to follow in the adjunct game, the system will place that player into a group that is “under construction” according to certain selection criteria. The criteria may follow a hierarchy as follows:
If the player is physically at the selected sporting event according to the device location information (e.g. GPS or other location functionality as may be available in the smart phone), the player is matched to a group whose initial member is at the same event.
The player is matched to a group whose initial member is geographically within about 50 miles of the player by current location (if a location device is available).
The player is matched to a group whose initial member is within about 50 miles of the player by zip code.
The player is matched to a group whose average per-game winnings are within about 20% of the player's average per-game winnings.
The player is matched to any open adjunct game for the selected broadcast event.

The matching criteria list the first member of each group (the “founder”) by location and zip code and the average adjunct game score of all current players in the group. The system places each player into a game on the order of seconds of the selection, and fills each existing adjunct game group before beginning another group. If a group is not filled to capacity within about 10 seconds, game play may still be set to begin with a short-handed group. If no adjunct games are available, the player will become the first member of a new “under construction” group. As with all of the adjunct game play and entry parameters, one would understand that these parameters are not fixed, and can be set to a variety of different approaches.

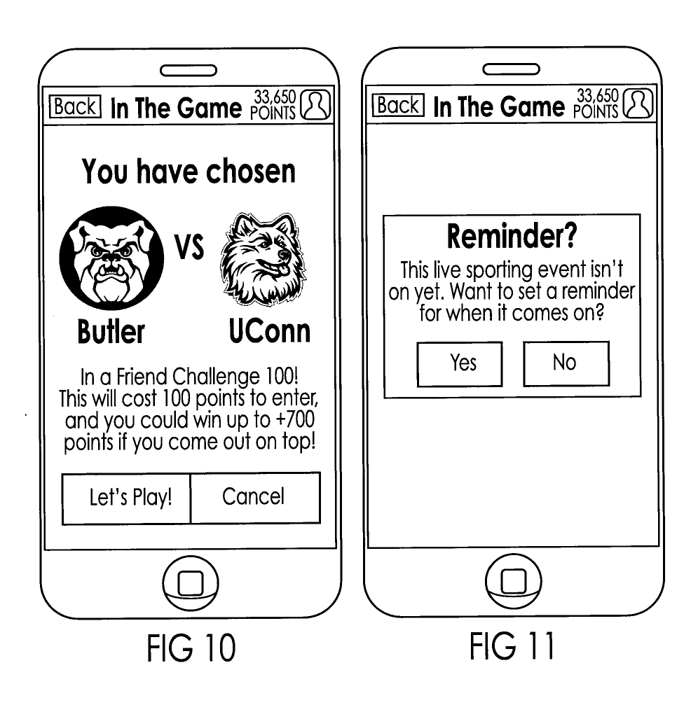

Using college basketball as an example of a sporting event, a player can select between sporting events such as Ohio State vs. Kansas, Oregon State vs. UC Berkeley, Oakland vs. Michigan, or UConn vs. Butler. The player can then set up how they want to engage with the live sporting event and determine which event to select, as illustrated in FIG. 9. This example lists several college basketball games from which a player can choose. FIG. 10 illustrates confirmation of an exemplary selection of the Butler vs. University of Connecticut college basketball game. If the sporting event has not yet started, a message can be sent to the player, asking if they wish to set a reminder for the sporting event (FIG. 11). Until the sporting event starts, the main play screen will not show any scores or ticker events. Also, the player may be allowed to make unlimited athlete substitutions until the sporting event starts.

Next, the player then selects the desired athlete(s). One exemplary user interface for facilitating selection of the athletes is shown in FIG. 13. The player chooses a starting athlete by selecting a “Choose Starter” button. The starting athlete(s) can be chosen before the game starts, but it is possible that the starting athletes could be selected after the start of the sporting event particularly where the adjunct game begins after the start of the sporting event. In one embodiment, each player of the adjunct game may select two athletes (or more) to “play” for them at the same time. Depending upon the sporting event and/or the predetermined rules set for the game play, adjunct game players can select one or more athletes, based upon how the player believes that athlete will perform. The number of athletes selected at one time may be determined by the sport itself, or determined by the player group before the adjunct game begins. Once the starting athlete(s) are chosen by the player, the athletes' portrait, name, or other indicators may appear on the screen. In the exemplary interface, the “Choose Starter” button may now say “Change Athlete.”

Once the sporting event begins, the player may begin amassing points as their selected athlete(s) perform certain tasks, or actions as indicated by the information provided by the play-by-play information. During the course of an adjunct game, advertisements can be presented on the user interface, especially during slow moments in the sporting event (e.g., timeouts, injuries, or half-time). The player can interact with the main play screen as usual during the adjunct game play. The adjunct game also has several options, where a player can change the settings of the adjunct game. Once the sporting event is completed, the player can see if he won any loyalty points by clicking a collect button, or otherwise access a screen where the player can collect any loyalty points won.

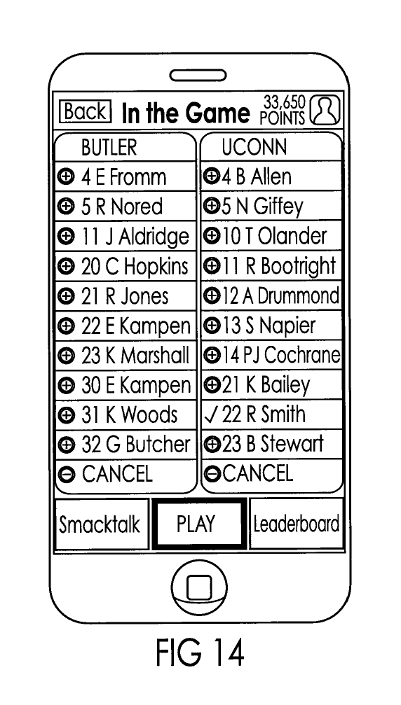

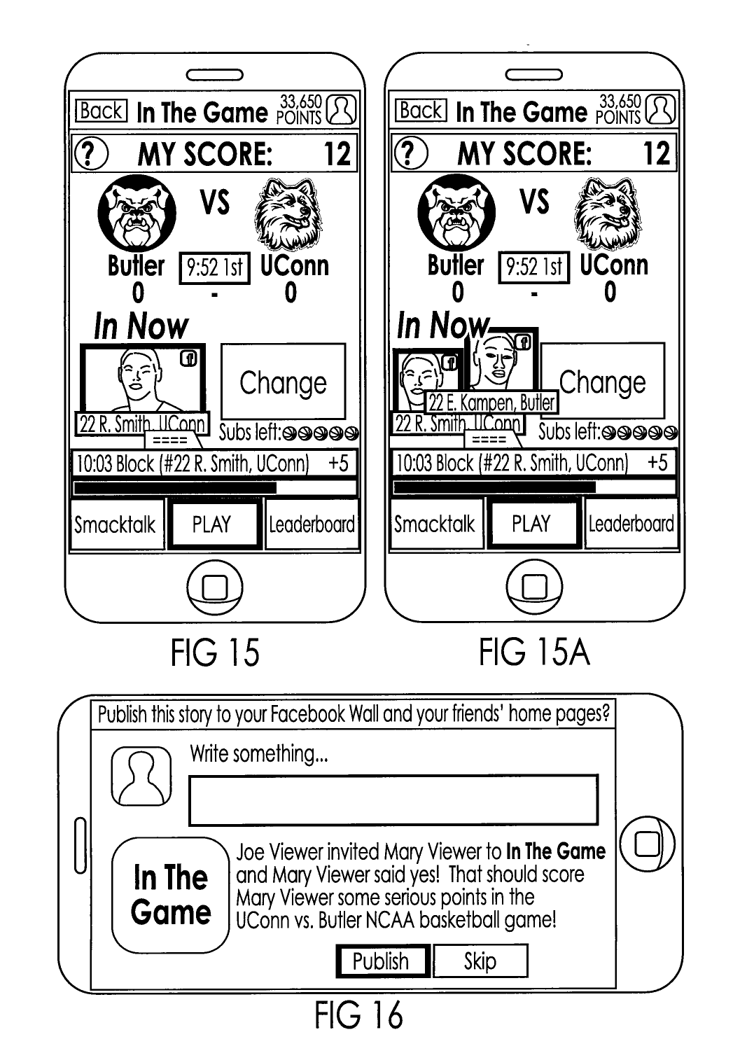

During the adjunct game, a player's screen may show a variety of information. As illustrated in the figures, the screen may show all or a combination of the player's score, the current selected athlete(s), game logos (e.g., team logos for those teams engaged in the underlying sporting event), sponsor branding (if any), a rolling ticker window with a pull-up handle (see FIG. 21), a display that shows any current athlete streak status, the scoring leaderboard, athlete rosters and statistics, the time left in the sporting event, the player's total accrued points, the number of substitutions available to a player, a button (or other method) that allows a player to navigate to previous screens, a help button or icon, and a button (or other method) that allows a player to change their selected athlete. When a player wants to substitute an athlete, they can select a “change athlete” button, which will preferably bring up a list of the athletes in the current sporting event. As shown in FIG. 14, the list may be a scrollable roster that allows a player to navigate the rosters (in the example the rosters of Butler and U Conn) and select the athlete they wish to have in the adjunct game. As depicted, the player may select the desired athlete by clicking on their name or an associated button. In addition, a Facebook® (or other social media) icon can be included, which allows a player to share their choice of athlete with their social media friends. FIGS. 15 and 15A illustrates one embodiment of the screen during play, which shows an image of the selected athlete. FIG. 15 shows a single athlete selection and FIG. 15 A shows two selected athletes. If the social media icon is selected, a pre-determined message may be created for generation of message to share with the player's friends. FIG. 16 gives a player means to provide information on the adjunct game to their Internet universe. A player can publish a story about the adjunct game and the individual players to their wall or other website.

The adjunct game relies upon a substantially real-time play-by-play feed for events that occur within the sporting event. This feed may be provided by a third-party vendor, such as Stats LLC or The Sports Network. It is also contemplated that the system provider could generate their own play-by-play information. The real-time play-by-play data may typically be delayed by a few or more seconds from its occurrence in the live sporting event, so the players that are actually present in person at the sporting event may see a short delay between the athlete's performance and registration of the event within the adjunct game. It is contemplated that animation of an athlete change may be used to distract the player from the delay in the acquisition of data and information.

As illustrated in FIG. 21, each sporting event may have a ticker associated with the user interface where at least selected play-by-play information from the live sporting event may be displayed. The player may be able to scroll through the play-by-play information. The ticker window may be expanded using a vertical handle. Alternatively, the pull-up handle can have a horizontal handle. The ticker preferably lists the athletes' performance and will ultimately indicate the winner of the live sporting event. As each scoring event occurs on the ticker, the event may be highlighted. For instance, positive in adjunct game scoring events can be highlighted (e.g., in yellow, bright green, or any other desired color scheme) whereas negative events can be highlighted in red or any other desired color. Scoring events for unselected athletes may also be highlighted for example in grey.

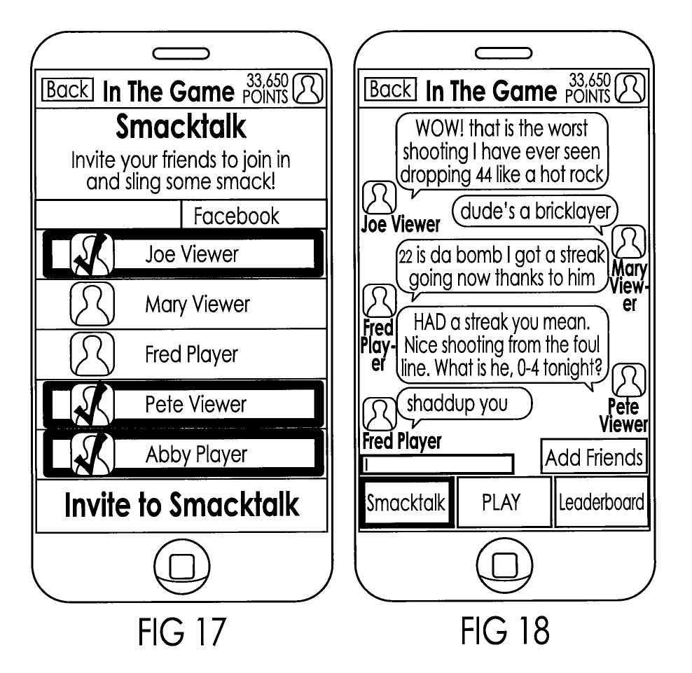

Additional buttons or other selectable icons relating to the adjunct game's “smacktalk” feature, leaderboard access, and game play may be located on the user interface, so they are accessible to a player during adjunct game play. For example, as shown in FIG. 17, a “smacktalk” button may be provided that brings up a chat stream with other players in the selected game, where a player can invite other players to discuss the game in a humorous and provocative manner, like that illustrated in FIG. 18. The “smacktalk” chat stream can be governed by predetermined rules, including allowed language and discussion topics, but is expected to provide a forum for players to dish on each other and/or their chosen athletes and teams. If desired, “rules” for each “smacktalk” chat room can be set forth, outlining the behavior and language of the players.

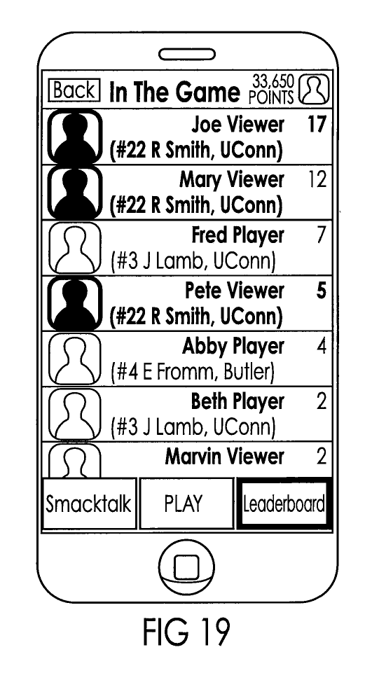

The leaderboard button will cause the screen to switch to a leaderboard screen, which shows the current scores for all friends (Facebook® or other social media circle of friends) and followers in the free play mode. If in a challenge mode (e.g., friend challenge 100, open challenge 100, or open challenge 1,000), each of the competitor's scores is shown. If a player taps on a team logo, that team's roster may be brought up. The roster lists the athletes and their current season statistics. Alternatively, the rosters and season statistics for both teams playing in the live sporting event can be shown. FIG. 19 is a screen shot illustrating one exemplary leaderboard in an adjunct game, which illustrates that player #22, R. Smith has been chosen by several players, including Player 1 (aka Joe Viewer), or the originator of the game. The number of points each player has accumulated is dependent upon how their selected athlete(s) perform, and how often (and for whom) the athletes are substituted.

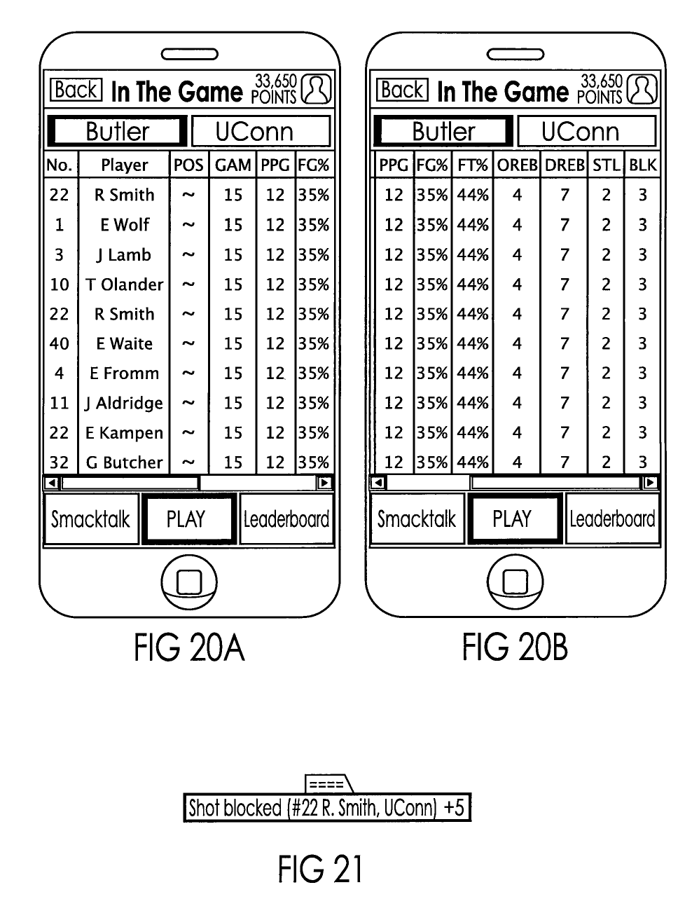

All data may be presented in scrollable form, so that data that spans more than the size of the display of the user's device can still be viewed by the player. FIGS. 20A-20B illustrate screen shots of the entire Butler roster, and can be scrolled through to see their statistics and performance. It is noted that several of the screens have scrolling functions, so that with scrolling and movement of the cursor, more data and information can be seen and reviewed by the players.

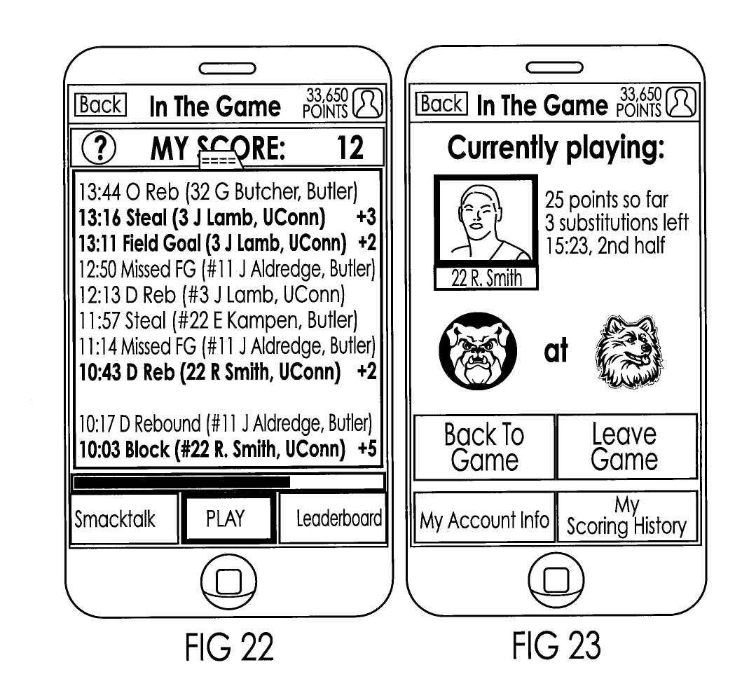

FIG. 22 is one potential embodiment of a user interface illustrating the overall play of a particular adjunct game. In particular, this illustration shows how the selected athletes performed within the particular game. For example, J. Lamb was selected as the first athlete, with the player gaining 5 points on Smiths play in the underlying sporting event. Next, R. Smith was substituted for Lamb, and netted the player another 5 points, giving the player 12 game points. FIG. 23 depicts one potential user interface showing the player's currently selected athlete, the player's performance (“25 points so far”), the number of substitutions remaining and the time remaining in the live sporting event. From this example screen, a player could return to or leave the adjunct game. Also, the player could open their account information and/or their scoring history.

As shown in FIG. 22, a display showing any athlete's current streak status may be located below the ticker, although in other embodiments, it can be located elsewhere on the screen or accessible through clicking a button. The streak display fills up as positive events occur for a player's athlete. As the streak continues to be alive, the display can have a visible indication, such as a glow or a highlight effect. In one embodiment, the game points given to the player due to an athlete's plays can be doubled or otherwise increased as a streak continues and increases. The increased scores can have a similar glow or highlight as the streak display. In addition, other indicators of events during a streak can be shown as helping a player's score (highlighted, for example, in yellow or other distinguishing color). Events that do not effect a player can be greyed out or otherwise not highlighted in any way.

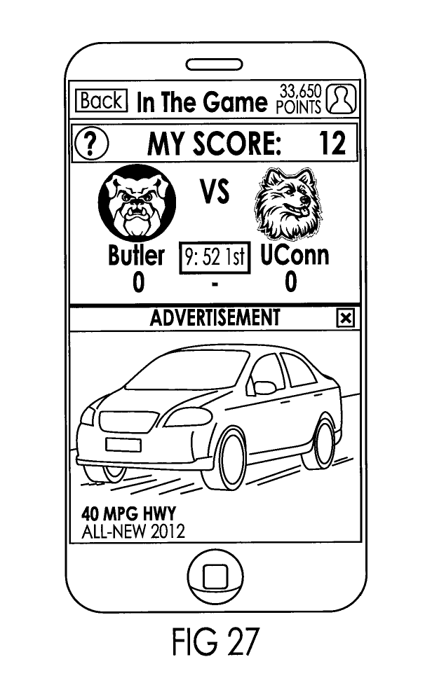

During timeouts in the real-time sporting event or other sport-specific breaks (e.g., between quarters or periods, during timeouts, change of possession, between innings or portions of innings, or even during a caution in an automobile race), ads can be served or displayed to players. These ads can be advertisements for products or services, or reminders to the players that they could earn more points by performing certain actions. For example, if a player checked into the broadcast through the underlying system (described below), they may be able to earn extra game or loyalty points. FIG. 27 shows one approach to displaying an advertisement within the game. While the adjunct game is in progress, the advertisements can be sent to the players. In one embodiment, the players can click on the advertisement and view additional content or visit the advertiser's website.

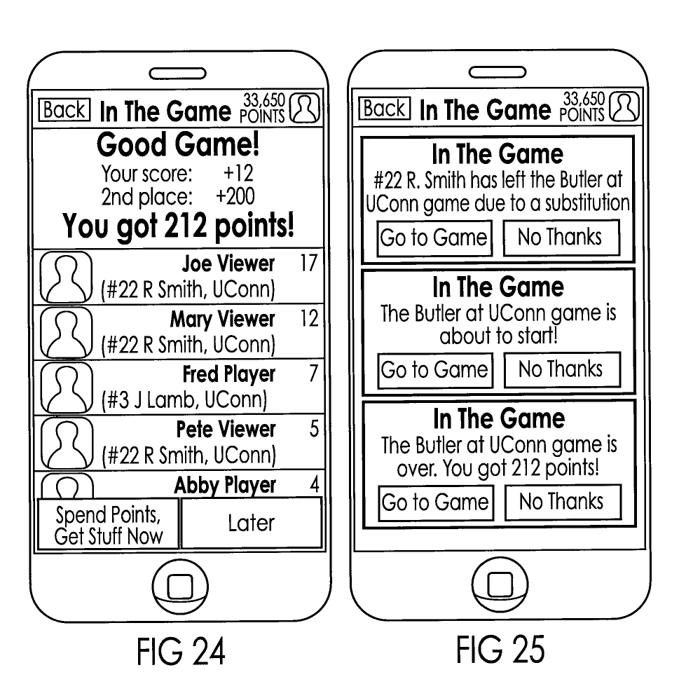

At the end of the live sporting event, a player may be provided with a scoring summary, which may even emulate a scoreboard view. The scoring summary can include a button or other access so the player can determine whether they will be awarded any loyalty points for their performance in the game. Options for collecting winnings may include a “collect” and “Not Now” buttons to defer collection of the winnings. At the end of the adjunct game, a player may log out. FIG. 24 illustrates one user interface approach to a simplified “logout” screen. In particular, after a viewer has chosen to log out of the system they are provided with information about the just terminated adjunct game session. In addition, the logout screen provides a simple way to obtain rewards after an adjunct game is completed.

Other general notifications that may be included in the adjunct game including notification to a player when their selected athlete is removed from the live sporting event (by injury, substitution, penalty, or ejection), when the live sporting event and adjunct game begin, and/or when the live sporting event or adjunct game is completed.

FIG. 25 illustrates notification screens that may be provide in the adjunct game. These screens may be visible even if the player is not actively following watching the live sporting event in question. The top screen illustrates a message that may generated when an athlete has left the live sporting event. As illustrated the message may provide the adjunct game player the option substituting an athlete or declining to do so. The middle screen illustrates a message that may be generated to remind the player that a sporting event for which the player wanted to play in an adjunct game is about to start. Again, the player has the option to go to the adjunct game or decline. Finally, the bottom screen illustrates another potential reminder window informing the player that the live sporting event has ended with information regarding how the adjunct game went. The player then has the option to go to a different adjunct game or decline.

At the end of the live sporting event, the notification might include the player's score for that adjunct game, the player's finishing place in the adjunct game, the number of awarded points accrued by the player, and the awarded points accrued by other players in the game. Buttons (or other access methods) can be displayed so that a player can click and be sent to a reward screen, so that the player might convert their awarded points to loyalty points, and then spend their loyalty points and receive prizes or other awards. The final screen may be scrollable, so that all the players' results can be viewed.

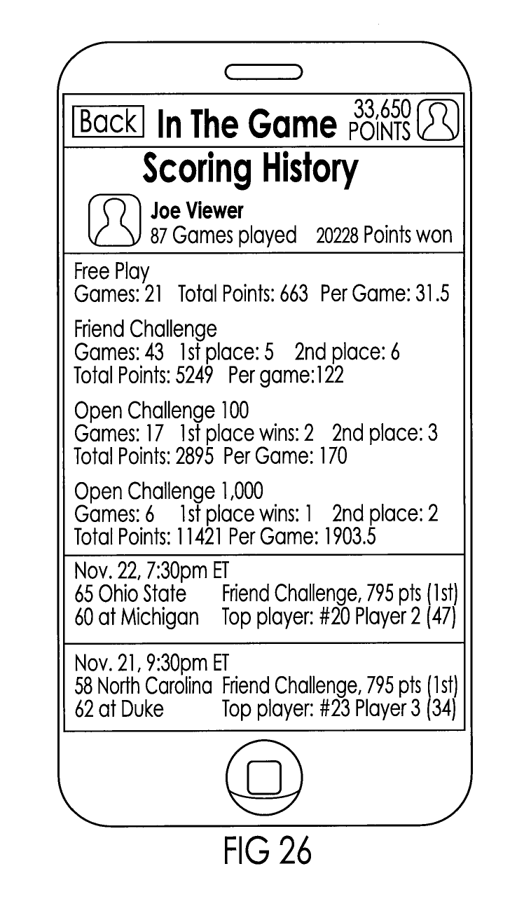

The game may also include an Options screen, which may be accessed during adjunct game play and which shows an illustration of a player's selected athlete(s). Other information that can be displayed on the Options screen includes, but are not limited to the athlete's performance, the number of substitutions left to a player, the adjunct game that is being played, and buttons to return to the adjunct game, leave the adjunct game, view the player's account information or scoring history. One of ordinary skill in the art can envision other options that may be or become available to a player. For example, a player can abandon one adjunct game and enter another. In one embodiment, the player keeps any accrued points, and can even win an abandoned adjunct game, if the player's point total remains above the other players. Players can also adjust their settings from this screen, and can edit information, or enable or disable game functions, such as the notifications. The player can also view their entire history of playing the adjunct game, including a scrollable list of the types and dates of adjunct games played. FIG. 26 provides an illustration of a players competition history when playing the adjunct game over time. The history can list the number and type of adjunct games played, the points won by that player, as well as specific information from particular games. The player's name and overall summary, however can be locked. It is envisioned that this game can be formatted as an application that can be integrated with social media sites, such as Facebook®.

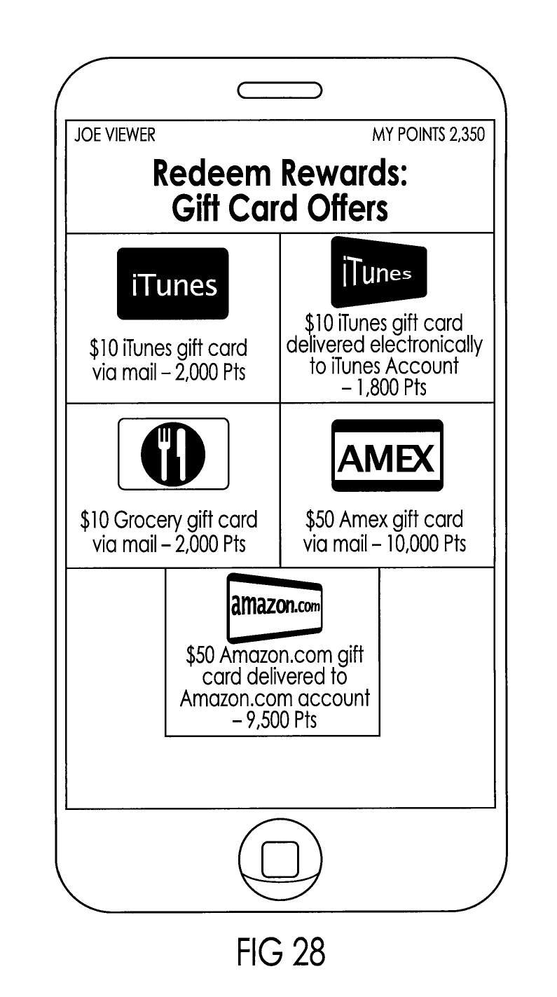

As illustrated with respect to FIG. 28, the reward account may include loyalty points that can be redeemed for rewards, cash or store credits, or other cash equivalent rewards (e.g. send restaurant/retailers/grocery gift card, offer pay a portion of the cable bill, pay a portion of mobile phone bill, donation to charity, a movie ticket coupon); tangible prizes (such as selected directly from an on-line catalog, won in an on-line auction, won as part of a sweepstakes); incentives prizes (e.g. drawn into a particular television show or video, exclusive video content, free ring tones); and any combination of the foregoing, or other similar types of promotional or loyalty rewards.

For instance, one reward may consist of mobile phone offers, such as paying a portion of the monthly cell phone bill or paying for unlimited SMS messaging. Another similar potential reward offering is payment of a portion of the cable bill, such as the basic subscription fee, or for a particular on-demand or pay-per-view movie. The categories of reward offers fills the visible screen (and probably continues onto virtual screens that may be accessed by swiping a finger across the screen of smart phone 55. For example, if the viewer 40 selects the “gift card” category, the user interface shifts to FIG. 28 where a variety of gift cards are displayed. In the illustrated example, the available gift card offerings all fit within the single screen. The viewer 40 selects a particular gift card offer, such as the $10 iTunes gift card via regular mail offer causing the user interface to shift the number of point necessary to “buy” the reward, and a description of the reward (and any special terms and conditions) are displayed. As also illustrated, once the viewer 40 has decided that they want the reward, they press the “Redeem” button, which will debit the reward point account of viewer 40. The system may provide the viewer 40 with a potential alternative acquisition (e.g. an electronic iTunes gift card for fewer points).

Another reward example is a sweepstakes entry. Here, the user interface provides a description of the reward and the number of points needed to enter the sweepstakes. As further depicted, the system may inform the viewer of the current number of entries in the sweepstakes and the time remaining to enter. Reward points are deducted upon entry into the sweepstakes regardless of whether the viewer wins. Where applicable, sweepstakes rules may apply.

Another potential user interface relates to an online auction reward option. The interface will provide a description of the reward, an opening bid, a current bid, and the remaining time to enter a bid. As would be understood, bid entry would be limited to amounts that are greater than the current bid. Even if a bid is acceptable, the reward points will only be deducted if the viewer 40 wins the auction.

Data regarding each user's point redemption activities may be utilized to capture user preferences, including but not limited to, brand preferences. For example, a user redeeming points for a Coca Cola T-shirt may indicate a preference for Coke. Similarly, redemption for a 4-pack of razor blades may indicate a desire for a particular product as approved by others.

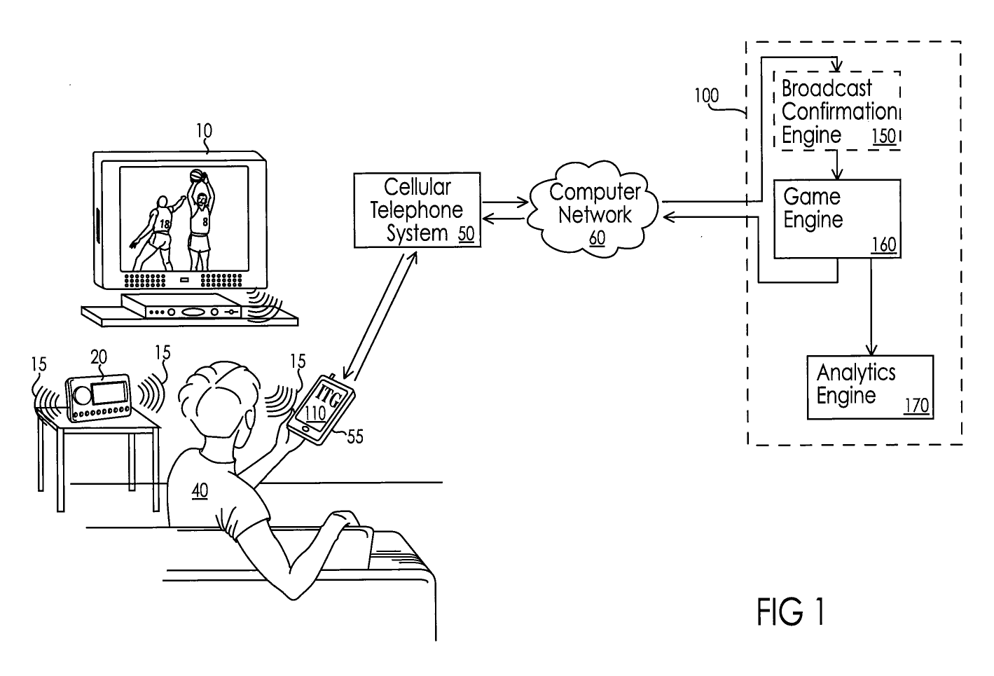

Turning to the system required to play the adjunct game, FIG. 1 illustrates one embodiment of a system 100 and its potential avenues for interaction with the real world toward implementing the concepts of the present invention. In particular, system 100 communicates with viewer 40 via a computer application 110 that has been installed on the smart phone 55 in a player's hand. System 100 may also communicate with player 40 via SMS, MMS, push notification, and other types of messaging (not shown) that are or may become available on smart phone 55. Although the specification has been phrased in terms of smart phone 55, it should be understood by those of ordinary skill in the art having the present specification, drawings, and claims before them that in some approaches to the present invention it would be possible to utilize any telephone or even computer for transmission into system 100.

Instead of a smart phone, a computer may be used, and may be any type of computer, such as desktop, laptop, or tablet computer that can preferably operably connect to the computer network 60. A computer should include a video display and a browser capable of rendering content from social media sites such as Facebook® to enhance the viewer experience in interacting with the system 100. A computer may also have the application 110 installed thereon. The application 110 installed on a computer may be a different or the same application that is installed on smart phone 55. It is possible for the application to have a slightly different look and feel on a computer than on smart phone 55 because of the additional screen space, however, it is preferred that the look and feel be sufficiently similar to invoke the same feeling in the viewer with respect to the interaction with the system 100. As such, the application 110 on a computer could also be used to log into the game.

The smart phone 55 is connected to the system 100 via a cellular telephone system 50 and computer network 60. The cellular telephone system 50 may be any type of system, including, but not limited to CDMA, GSM, TDMA, 3G, 4G, and LTE. To facilitate the use and bi-directional transmission of data between the system 100 and smart phone 55, the cellular telephone system 50 is preferably operably connected to computer network 60 in a variety of manners that would be known to those of ordinary skill in the art.

System 100 may further communicate with player 40 via computer 30 that is operably connected to the system 100 via the computer network 60. The computer network 60 used in association with the present system may comprise the Internet, WAN, LAN, Wi-Fi, or other computer network (now known or invented in the future). It should be understood by those of ordinary skill in the art having the present specification, drawings, and claims before them that the computer network 60 may be operably connected to a computer (not shown) over any combination of wired and wireless conduits, including copper, fiber optic, microwaves, and other forms of radio frequency, electrical and/or optical communication techniques.

As shown in FIG. 1, in some embodiments of the system, a device, such as smart phone 55 is used to log into an adjunct game that player 40 is currently watching. For instance, FIG. 1 depicts the viewer 40 listening to a television 10 or a radio 20. The television 10 may be broadcasting a live sporting event that was delivered to the television 10 from various sources, such as cable set top box or satellite receiver 11. The radio 20 may also be broadcasting sporting events via AM, FM, HD radio and/or satellite radio programming into the living room of viewer 40. Alternatively, the user may have already accessed the adjunct game application 110, but still needs to log into the system to play the adjunct game. In one embodiment, the player, or viewer, may be exposed to a question or other means to determine if the player is actually watching or interacting with a selected sporting event. Alternatively, the system may be able to detect an embedded audio or video fingerprint or watermark embedded in the broadcast of the live sporting event.

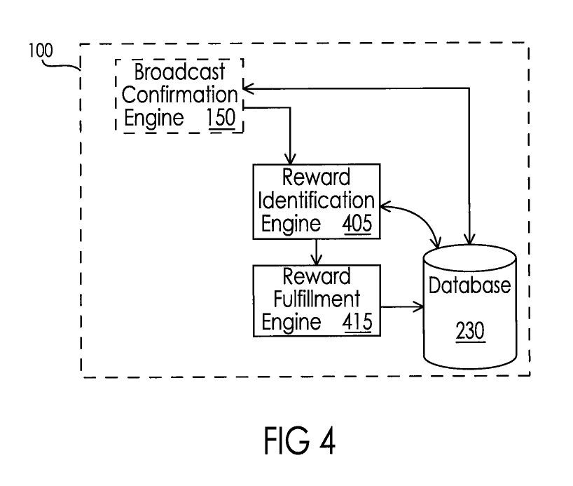

System 100 includes the application 110, a broadcast confirmation engine 150, a game engine 200, and an analytics engine 170. The application 110 may be pre-installed on computer (not shown) and/or smart phone 55. However, as depicted in FIG. 4, after viewers learn about system 100, it is primarily contemplated that the viewer 40 may download the application 110 from one of a variety of sources including, but not limited to the iTunes AppStore, Android application marketplace or a dedicated website. It is alternatively contemplated that the viewer 40 may send an email to a dedicated website and receive, in return, a copy of the application 110 for installation. It is also contemplated that the viewer 40 may send a predetermined SMS message to an enumerated short code (e.g., Send JOIN to 55512) and receive instructions for interacting with system 100 via a return SMS message. Finally, it may be possible for viewer 40 to register on the website without downloading the computer application 110. In such a case the application 110 may be invoked from the website (or otherwise in the cloud).

Although the various aspects of system 100, such as broadcast confirmation engine 150, game engine 160, and analytics engine 170 have been illustrated as being singular and co-located with one another to avoid obscuring the invention, as should be understood by those of ordinary skill in the art having the present specification, drawings, and claims before them it is contemplated that the various aspects of system 100 may be deployed across the globe in the cloud or on a plurality of servers, which may provide redundant functionality to allow quicker—substantially real-time—processing. In fact, it should also be understood that certain aspects of the broadcast confirmation engine 150 could even be deployed onto the smart phone 55 and/or computer of each viewer 40.

The broadcast confirmation engine 150 allows, by various means including answering a question, detecting an embedded fingerprint or watermark, or any other means of determining that the viewer is actually watching or listening to a selected live sporting event. Then, broadcast confirmation engine 150 compares the resulting question answer, fingerprint or watermark to information stored in a database to determine whether the viewer 40 is watching or listening to the selected game Thus, the broadcast confirmation engine 150 sends data that allows for confirmation that the viewer 40 is presently experiencing the live sporting event, for which loyalty points can be awarded.

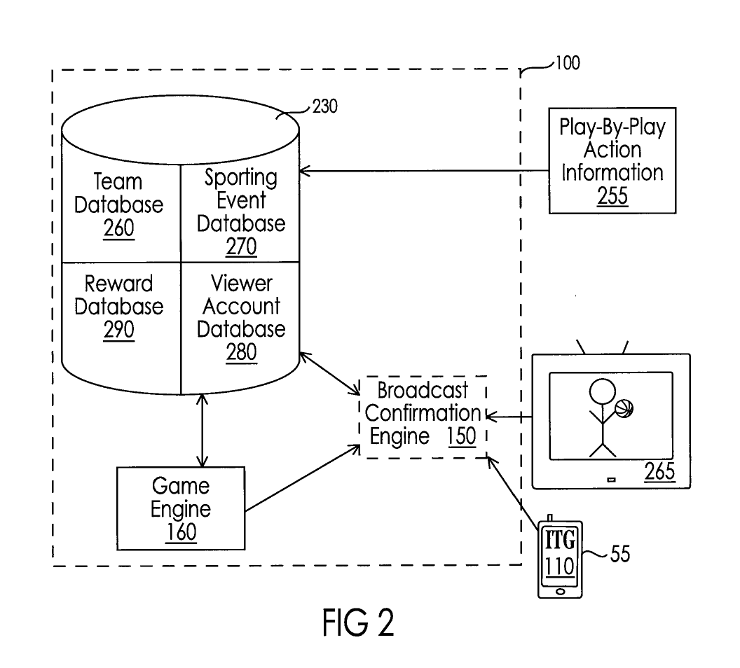

FIG. 2 illustrates one embodiment of the invention, including means for receiving data indicative of certain play-by-play information relating to the selected live sporting events and athletes. The selected content is compared to viewer's selections, which are stored in database 230. Audio and/or video information may be provided to system 100 from a plurality of broadcast channels 265 in substantially real-time. The plurality of broadcast channels 265 would be selected from those channels playing sporting events. Although the database illustrated in FIG. 2 is a unified database that stores at least four types of information, it should be understood that four databases could be used. The viewer accounts may be stored in database 280. The viewer accounts can include viewer identification information (name, address, log-in information, network information (e.g., the viewer's cable or dish provider), the adjunct games the viewer previously accessed and played, any selection of future live sporting events, the athletes selected by the viewer, and any viewer “favorites” that might be tracked and stored, such as favorite sports, teams, or athletes In addition, a viewer's redemption history may also be stored in the viewer account database 280. Database 270 may include live sporting event information, including matchups, game time, game broadcast channel (by provider), and information relating to that sporting event. Database 260 may be used to store information relating to the teams in each sport, their logos, the team athletes (and their uniform numbers and an identification number), the athletes' past statistics and projections for future athlete performance. A fourth database 290 may be used to store reward information including reward type and loyalty point value required to redeem for each rewards. Reward types can include gift cards, videos, team apparel and gear, and even sporting equipment. Alternatively, each of these database selections can be a stand-alone database.

As shown in FIG. 4, the reward identification engine 405, identifies rewards that will be given to the viewer if the viewer participates in certain behaviors via the reward fulfillment engine 415. For instance, as shown in the example above, reward identification engine 405 granted the viewer points for simply logging into the system, watching particular live sports event content (e.g. the basketball game) in real time, and sending a status update to social media (e.g. Facebook®) from within the system 100. The point values assigned to each action may be determined by the reward identification engine 405 on a viewer-by-viewer basis depending upon the demographics and prior usage patterns of the viewer 40. The point values may be further adjusted by the interests of live sporting event providers in attracted and/or retaining viewers with the demographic and/or usage patterns of the viewer. Based on data stored in database 230, the reward identification engine 405 may have provided a text message via computer application 110 or an email to the viewer to encourage that viewer to participate in the social network.

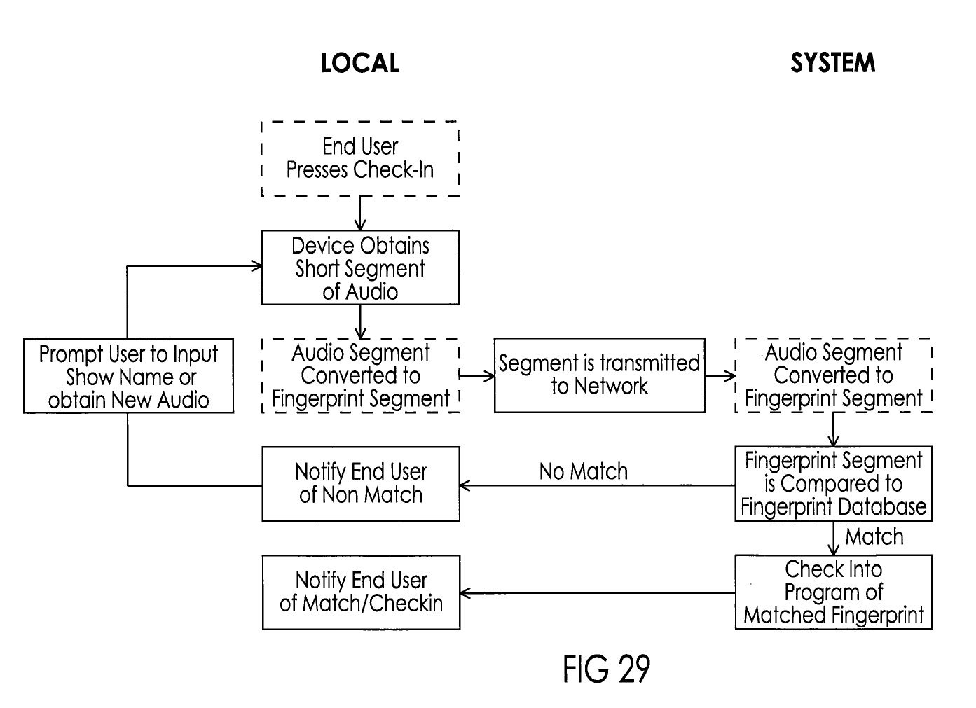

As illustrated in FIG. 29, another embodiment of the invention illustrates when the computer application 110 (previously installed on smart phone 55) is activated, it will capture a moment of the ambient audio 15. FIG. 29 depicts the process whereby the system obtains and checks an audio sample. If the fingerprint segment of the audio sample is successfully matched to a fingerprint in the fingerprint database, then the viewer is notified of the successful check-in. If the fingerprint segment of the audio sample is not successfully matched to a fingerprint in the fingerprint database, then the viewer is notified of the non-match. If there was a non-match, the viewer may be given an opportunity to try matching again (by obtaining a new short audio segment) or by inputting the name of the program automatically or finding the show via a “SEARCH” button, thus providing a textual search of the content programming listings.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A system for encouraging one or more viewers to engage with a live sporting event comprising:
means for receiving log-in information from one or more viewers operably connected with a database for storing viewer accounts;
means for receiving a selection of a live sporting event from each of the one or more viewers operably connected to a database for storing information relating to live sporting events;
means for receiving a selection of at least one athlete participating in the selected live sporting event from each of the one or more viewers operably connected to a database for storing team information;
means for receiving data indicative of certain play-by-play action in substantially real-time for the selected live sporting event;
means for comparing the data indicative of certain play-by-play action with each of the viewers' selected athlete; and
means for awarding points to each of the viewer's if the selected athlete performs a pre-designated act.

2. The system according to claim 1, further comprising:
means for rewarding the viewers based upon their awarded points operably connected to a database for storing reward information.

3. The system according to claim 2, wherein the awarded points are equivalent to loyalty points.

4. The system according to claim 3, further comprising a reward fulfillment engine that facilitates the viewer's redemption of the points for rewards and distributes the rewards.

5. The system according to claim 4, wherein the reward fulfillment engine provides a catalog containing a plurality of rewards that can be selected by the viewer by redemption of a predetermined number of loyalty points.

6. The system according to claim 2, wherein the awarded points are converted to loyalty points.

7. The system according to claim 6, further comprising a reward fulfillment engine that facilitates the viewer's redemption of the points for rewards and distributes the rewards.

8. The system according to claim 7, wherein the reward fulfillment engine provides a catalog containing a plurality of rewards that can be selected by the viewer by redemption of a predetermined number of loyalty points.

9. A method for encouraging one or more viewers to engage with a live sporting event comprising:
receiving on a central computer log-in information from the one or more viewers;
receiving on a central computer a live sporting event selection from each of the viewers;
receiving on a central computer a selection of at least one athlete participating in the selected live sporting event;
receiving on a central computer data indicative of certain play-by-play action in the selected live sporting event in substantially real-time;
comparing the received data indicative of certain play-by-play action with each of the viewers' selected athletes; and
awarding points to the viewers if the selected at least one athlete performs a pre-designated act.

10. The method of claim 9, further comprising:
allowing the viewer to substitute at least one athlete for the at least one selected athlete; and
awarding points to the viewer if the substituted at least one athlete performs a pre-designated act.

11. The method of claim 9, wherein the awarded points are equivalent to loyalty points.

12. The method of claim 11, further comprising:
facilitating the viewer's redemption of the loyalty points for rewards.

13. The method of claim 12, wherein facilitating the viewer's redemption of loyalty points includes sending a real-world reward to the viewer.

14. The method of claim 9, wherein the awarded points are converted to loyalty points.

15. The method of claim 14, further comprising:
facilitating the viewer's redemption of the loyalty points for rewards.

16. The method of claim 15, wherein facilitating the viewer's redemption of loyalty points includes sending a real-world reward to the viewer.

17. The method of claim 9, wherein the live sporting event is selected from a baseball game, a basketball game, a college football game, a professional football game, a hockey game, a soccer match, and an automobile race.

18. The method of claim 17, further comprising determining if the one or more viewers are watching or listening to a broadcast of the live sporting event.

19. The method of claim 17, further comprising determining if the one or more viewers are watching or listening to the live sporting event in the sporting arena.
